(19) United States
(12) Patent Application Publication
(10) Pub. No.: US 2007/0153655 A1
(43) Pub. Date: Jul. 5, 2007

(54) Method and apparatus of determining and storing optimized power calibration data for recording medium

(75) Inventor: Yao-lung Chuang, San-Chung City (TW)

Correspondence Address: MADSON & AUSTIN;GATEWAY TOWER WEST, SUITE 900, 15 WEST SOUTH TEMPLE, SALT LAKE CITY, UT, 84101, US

(73) Assignee: MediaTek Inc.

(21) Appl. No.: 11/321,667

(22) Filed: Dec. 29, 2005

(51) Int. Cl. G11B 7/00

(52) U.S. Cl. 369/47.53; 369/53.26

(57) ABSTRACT

In the present invention, an identification code of the recording medium is searched in a first memory and a second memory. If the identification code is failed to be found in the memories, an optimized power calibration (OPC) operation is executed to generate new OPC data. The new OPC data is stored in the first memory. If the identification code is found in one of the memories, a current temperature and a past temperature of the recording medium are compared. If a difference between the temperatures exceeds a predetermined value, then the OPC operation is performed. Therefore, unnecessary optimized power calibration (OPC) operations are avoided. The power used for the recorder is also adjusted according to the temperature variation.

### TECHNICAL FIELD OF THE INVENTION

The present invention relates to a method and apparatus of determining an optimized power calibration (OPC) data for a recording medium. In addition, the present invention relates to storing the OPC data and an identification code of the recording medium into a volatile memory.

### BACKGROUND OF THE INVENTION

Data can be recorded to a recording medium such as an optical disk by a pick-up head of a recorder with a proper power. The optical disks manufactured by different manufacturers may have different physical and optical characteristics. In order to record data to the optical disk with an optimized power, the recorder executes an optimized power calibration (OPC) operation to ensure the writing power is optimal for the optical disk. For a rewritable or recordable optical disk, which can be recorded over and over for many times or can be recorded data on different areas in different times, if the recorder executes the OPC operation whenever it records data to the same rewritable or recordable optical disk, it is a waste. Moreover, the characteristics of the optical disks can also be influenced by the environment such as the temperature. Therefore, if the recorder just records the rewritable or recordable optical disk with the same power each time without considering the variation in temperature, or other factors, the power used to write the optical disk might not be of the optimal value.

Therefore, there is a need for a solution to determine the optimized power in order to save the performance effort of the recorder at the same time also to give consideration to the environmental variation so as to ensure the applied power is optimal for the optical disk for each writing operation, for example.

### SUMMERY OF THE INVENTION

The objective of the present invention is to provide a method of determining an optimized power for a recording medium. The recording medium such as an optical disk has an identification code provided thereon. The method in accordance with the present invention can save the recorder efforts by avoiding unnecessary optimized power calibration (OPC) operations. In the meanwhile, the method in accordance with the present invention gives consideration to the environmental variations to make timely adjustments to the writing power of the recorder, so that the recorder can always record data to the optical disk with the optimal power.

Another objective of the present invention is to provide an apparatus, which implements the method described above. The apparatus records the optical disk with an optimal power without doing unnecessary OPC operations. In addition, when there is an environmental variation influencing the characteristics of the optical disk, the apparatus of the present apparatus can properly adjust the power applied.

In accordance with an aspect of the present invention, the method reads the identification code of the recording medium and searches the identification code in a first memory. If the identification code is failed to be recognized in the first memory, then a search of the identification code is conducted in a second memory. If the corresponding identification code is found in the first or the second memory, then an optimized power calibration (OPC) data related to the identification code is obtained. The recording medium is recording according to the obtained OPC data. If the identification code is failed to be found in the entire memories, an optimized power calibration (OPC) operation is executed to generate new OPC data for the recording medium. The new OPC data is then stored in one of the memories, preferably, the first memory, which is preferably a volatile memory.

The method further includes sensing a current temperature for the recording medium after the OPC data is obtained from one of the memories and comparing the current temperature with a past temperature recorded in the OPC data. If a difference between the current temperature and the past temperature exceeds a predetermined value, the OPC operation is executed to generate new OPC data.

In accordance with another aspect of the present invention, the apparatus includes a pick-up head to read the identification code of the recording medium. The apparatus has two memories. One of the memories stores some existed known optimized power calibration data. The apparatus further comprises a controller. The controller searches the identification code in the memories, and obtains the optimized power calibration (OPC) data related to the identification code if the identification code is found. If the corresponding identification code is failed to be found in the memories, the controller executes an optimized power calibration (OPC) operation to generate new OPC data for the recording medium and stores the new OPC data in the first memory.

The apparatus further has a temperature sensor to sense a current temperature of the recording medium. The temperature sensor provides the sensed current temperature to the controller. The controller compares the current temperature with a past temperature recorded in the OPC data. If a difference between the current temperature and the past temperature exceeds a predetermined value, the controller executes the OPC operation to generate new OPC data.

### BRIEF DESCRIPTION OF THE DRAWINGS

The present invention will be further described in detail in conjunction with the accompanying drawings, wherein:

FIG. 1 is a schematic illustration of an apparatus for determining a power to write a recording medium in accordance with the present invention; and

FIG. 2 is a flow chart generally illustrates a method for determining a power to write a recording medium in accordance with the present invention.

### DETAILED DESCRIPTION OF THE INVENTION

The present invention will be described in details in conjunction with the drawings.

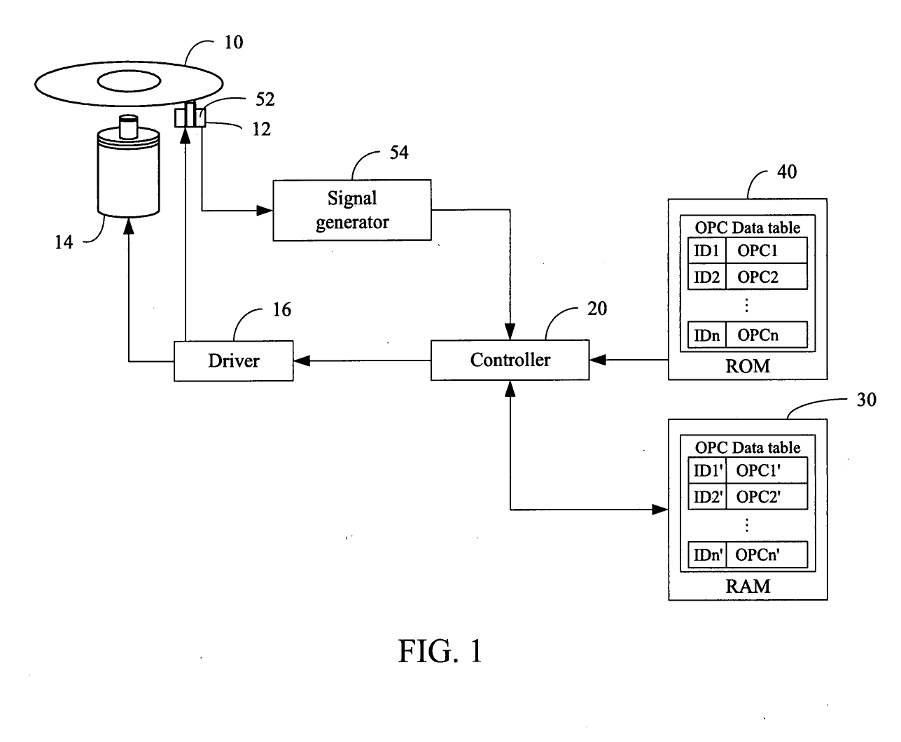

FIG. 1 schematically illustrates an apparatus for determining a power to write a recording medium in accordance with the present invention. As shown, the apparatus includes a pick-up head 12, which is used to read/write an optical disk 10 rotated by a spindle motor 14. The spindle motor 14 and the pick-up head 12 are driven by a driver 16. The apparatus further includes a controller 20.

The apparatus has a first memory 30 and a second memory 40. The first memory 30 has a first optimized power calibration (OPC) table, and the second memory 40 has a second OPC table. In the present embodiment, the first memory is a volatile memory, which is a random-access memory (RAM), for example. The second memory 40 is a non-volatile memory, which is a read-only memory (ROM), for example. In the other embodiments, the first memory and second memory are each selected from a volatile memory or non-volatile memory, but should be selected in different kind of memories. For example, if the first memory is a non-volatile memory, the second memory should be a volatile memory.

In the second OPC data table, the OPC data of some existed known optical disks are stored with identification information such as identification codes of the optical disks. As shown, ID1, ID2 . . . and IDn indicate the identification codes of the known optical disks, and OPC1, OPC2 . . . and OPCn indicate the OPC data of the optical disks. For example, if a known optical disk has an identification code ID1, the OPC data thereof is stored as OPC1, the rest can be deduced accordingly. Preferably, the OPC data table is built in the second memory 40 as the apparatus leaves the manufacturer's factory.

The first OPC data table of the first memory 30 is used to store the identification information such as identification codes and OPC data of unknown optical disks or identification codes and updated OPC data of known optical disks of which the original OPC data are stored in the second OPC data table. The apparatus performs the OPC operations according to the OPC data. As shown, ID1′, ID2′ . . . and IDn′ indicate the identification codes of those optical disks, and OPC1′, OPC2′ . . . and OPCn′ indicate the OPC data of the optical disks. For example, if an unknown optical disk has an identification code ID1′, the OPC data thereof obtained after the OPC operation is done is stored as OPC1′. The rest can be deduced accordingly.

According to the present invention, the OPC data includes other environmental factors. In this embodiment, temperature information is adopted for example. The temperature information indicates the temperature at which the OPC data is obtained.

The apparatus in accordance with the present invention further comprises a temperature sensor 52 and a signal generator 54. The temperature sensor 52 senses a current temperature of the optical disk to be identified and sends the sensed current temperature to the signal generator 54. The signal generator 54 generates temperature signal indicating the current temperature. The temperature signal is provided to the controller 20. It is noted that in addition to the temperature described above, other environmental factors can be considered in the OPC operation, and stored in one of the memories. The OPC operations with the considerations of other environmental factors are quite similar to the OPC operation with the consideration of temperature, and therefore the descriptions thereof are omitted for the sake of brevity.

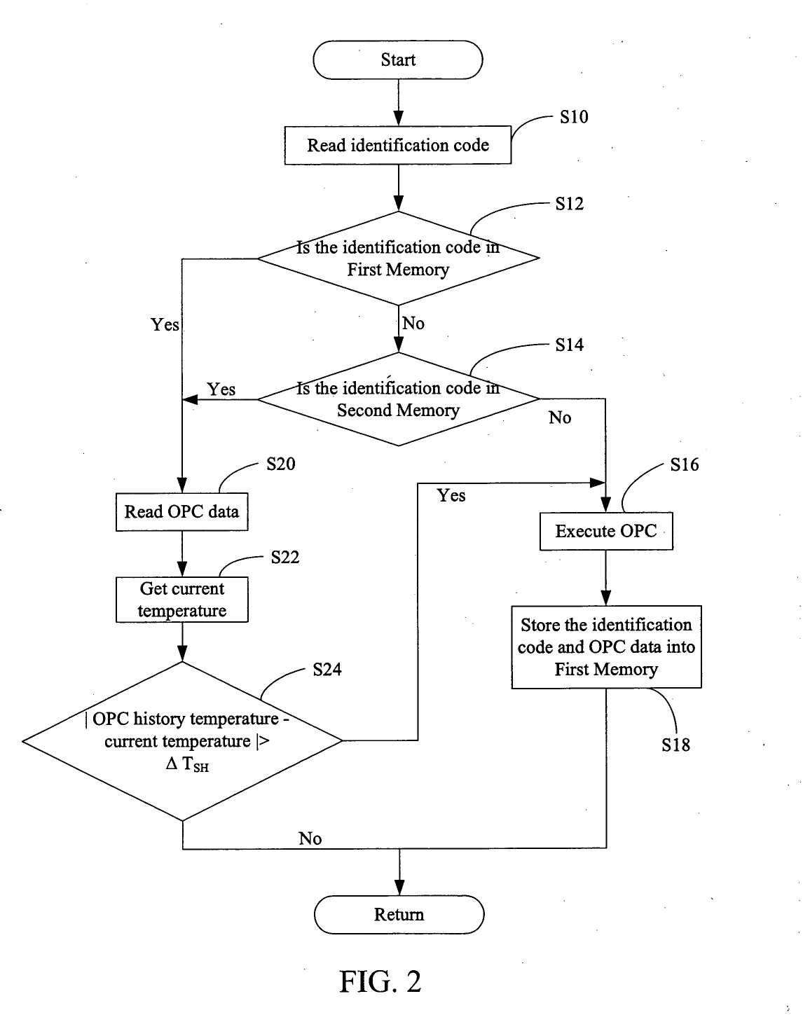

It is note that, the present invention adopts a volatile memory to store the updated OPC data for the recording medium which will help the whole performance of the optical recording system. The process of the apparatus in accordance with the present invention will be further described in details with reference to FIG. 2.

FIG. 2 is a flow chart generally illustrates a method of determining an optimized power for a recording medium in accordance with the present invention. According to FIG. 1, for a recording medium such as an optical disk to be recorded 10, the apparatus reads the identification code of the optical disk to be recorded 10 with the pick-up head 12 (FIG. 2, step S10). In FIG2, step S12, the controller 20 conducts a search in the first memory 30 to find the corresponding identification code. If the identification code is found, the process goes to step 20 to read the related OPC data stored in the OPC data table. If the identification code is not found in the first memory 30, the controller 20 conducts another search in the second memory 40 to find the identification code in step S12. If the identification code is found, the process goes to step 20 to read the related OPC data stored in the OPC data table. If the identification code is still not found in the second memory 40, the controller 20 executes an OPC operation to get a new OPC data for the optical disk 10 in step 16. The obtained new OPC data and the identification code of the optical disk 10 are stored in the first memory 30 in step 18.

As mentioned above, when the identification code of the optical disk to be identified is found in the first OPC data table of the first memory 30 or the second OPC data table of the second memory 40, the controller 20 reads the OPC data from the OPC data table in step 20. In step 22, a current temperature of the optical disk 10 is sensed by the temperature sensor 12, and the signal generator generates a current temperature signal based on the sensed temperature. In step 24, the controller 20 compares the current temperature and the past temperature recorded in the OPC data related to the identification code. If a difference between the past temperature and the current temperature exceeds a predetermined threshold ΔT_{SH}, the process goes to step S16, that is, the controller 20 executes an OPC operation to calibrate the writing power The newly obtained OPC data from the OPC operation including the temperature and the identification code of the optical disk are stored in the second memory 40.

Although the first memory 30 is searched first and the then the second memory 40 is searched to see if the identification code of the recording medium is stored in one of the memories in the present embodiment, the order of searching the memories can be changed as desired. For example, it is possible to search the second memory 40 first and then search the first memory 30 for the identification code.

By using the present invention, unnecessary OPC operations are avoided to lower the load of the apparatus. In addition, the writing power for the optical disk can be of the optimal level under varied temperature conditions or other environment factors.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. A method of determining an optimized power for a recording medium, said recording medium having identification information, said method comprising steps of:
reading the identification information of the recording medium;
searching a corresponding identification information in a first memory with respect to the identification information of the recording medium;
searching the corresponding identification information in a second memory if the identification information is failed to be found in the first memory;
obtaining optimized power calibration (OPC) data related to the corresponding identification information if the corresponding identification information is found in one of the memories;
executing an optimized power calibration (OPC) operation to generate new OPC data for the recording medium if the corresponding identification information is failed to be found in the memories; and
storing the new OPC data in one of the memories.

2. The method as claimed in claim 1, further comprising steps of:
sensing a current temperature for the recording medium after the OPC data is obtained; and
comparing the current temperature with a past temperature recorded in the OPC data;
wherein the OPC operation is executed to generate new OPC data if a difference between the current temperature and the past temperature exceeds a predetermined value.

3. The method as claimed in claim 1, wherein the identification information comprises an identification code of the recording medium.

4. The method as claimed in claim 1, wherein the new OPC data is stored in the first memory.

5. The method as claimed in claim 1, wherein the first memory is selected from the group consisted of a volatile memory and non-volatile memory.

6. The method as claimed in claim 5, wherein the first memory and second memory are different types of memories and the second memory is selected from the group consisted of a volatile memory and non-volatile memory, and the new OPC data is stored in the volatile memory.

7. The method as claimed in claim 1, wherein the first and second memory further stores a plurality of environment factors related to the OPC data.

8. An apparatus of determining an optimized power for a recording medium, said recording medium having identification information, said apparatus comprising:
a pick-up head for reading the identification information from the recording medium;
a first memory;
a second memory for storing at least one built-in optimized power calibration data; and
a controller for searching corresponding identification information in the first memory with respect to the identification information of the recording medium, searching the corresponding identification information in the second memory, and obtaining optimized power calibration (OPC) data related to the corresponding identification information if the corresponding identification information is found in one of the memories;
wherein the controller executes an optimized power calibration (OPC) operation to generate new OPC data for the recording medium and stores the new OPC data in the first memory.

9. The apparatus as claimed in claim 8, further comprising:
a temperature sensor to sense a current temperature of the recording medium, and provide the sensed current temperature to the controller,
wherein the controller compares the current temperature with a past temperature recorded in the OPC data and executes the OPC operation to generate new OPC data if a difference between the current temperature and the past temperature exceeds a predetermined value.

10. The apparatus as claimed in claim 8, wherein the identification information comprises an identification code of the recording medium.

11. The apparatus as claimed in claim 8, wherein the first memory is a volatile memory.

12. The apparatus as claimed in claim 11, wherein the second memory is a non-volatile memory.

13. The apparatus as claimed in claim 8, wherein the first and second memory further stores a plurality of environment factors related to the OPC data.

14. An optical recording apparatus comprising:
a pick-up head for reading an identification code from a recording medium;
a volatile memory;
an optimized power calibration (OPC) data generator for generating an optimized power calibration (OPC) data corresponding to the recording medium;
a controller for storing the OPC data and the corresponding identification code into the volatile memory.

15. The apparatus as claimed in claim 14, wherein the OPC data includes a temperature of the recording medium.

16. The apparatus as claimed in claim 14, wherein the controller compares a current temperature of the recording medium with the temperature recorded in the OPC data and executes the OPC operation to generate new OPC data if a difference between the current temperature and the temperature recorded in the OPC data exceeds a predetermined value.

17. The apparatus as claimed in claim 14, wherein the volatile memory further stores a plurality of environment factors related to the OPC data.
